(19) United States
(12) Patent Application Publication
(10) Pub. No.: US 2004/0010455 A1
(43) Pub. Date: Jan. 15, 2004

(54) Program, apparatus, and method of mediating sales

(75) Inventor: Junichi Iijima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 10/351,387

(22) Filed: Jan. 27, 2003

(30) Foreign Application Priority Data
Jul. 11, 2002 (JP) 2002-202966

(51) Int. Cl. G06F 17/60

(52) U.S. Cl. 705/26; 705/28

(57) ABSTRACT

In a sales mediation apparatus, a controller receives a request from a POS terminal installed in a store A (order receiving store), of a plurality of stores, having received an order of an article or articles from a customer, and searches for stock of the article or articles across the other stores. The controller manages one of the other stores having the stock as a store B (goods receiving store) from which the customer receives the article, together with the store A (order receiving store), and calculates commission for the store B (goods receiving store), based on information for sales notified from a POS terminal of the store B when the customer receives the article at the store B (goods receiving store).

### BACKGROUND OF THE INVENTION

1) Field of the Invention

The present invention relates to a program, apparatus, and method of mediating sales of goods between a plurality of stores, and capable of satisfying various needs of customers to enhance convenience, and making effective use of business chance on the store side.

2) Description of the Related Art

Conventionally, in the selling business, a large-scale marketing method has been employed. This method is such that headquarters develop a plurality of chain stores in many areas, based on standardized article concept, store design, and services. In such a marketing method, customers who visit a certain store, purchase articles as stock in the store, and bring the articles to their home.

However, in a conventional way, even when the chain stores are developed, a series of actions of a customer such as selection of articles, payment, and reception of the articles is restricted to the same store, and hence it is difficult to meet various customers' needs sufficiently.

Specifically, in conventional chain stores, customers' needs cannot be satisfied, causing a problem in that the customers' convenience is low. The needs are such that a customer wants to select an article or articles at the store A located in his/her work place and order the article without paying for it or receiving it, but receive the article and pay for it at the store B in his/her his place of residence later.

Further, if a customer wants to purchase a large or heavy article at the store A away from his/her place of residence, transportation cost from the store A to his/her own home has to be paid by the customer, which may cause the customer to cancel the purchase. In such a case, the store side will miss a business chance.

### SUMMARY OF THE INVENTION

It is an object of this invention to provide a program, apparatus, and method of mediating sales capable of satisfying various customers' needs to enhance the convenience, and making effective use of a business chance on the store side.

The sales mediation program, according to one aspect of this invention, by which a computer functions as a stock search unit that receives a request from an order receiving store, of a plurality of stores, having received an order of an article or articles from a customer, and searches for stock of the article or articles across the other stores. The computer also functions as a management unit that manages one of the other stores having the stock hit as a result of search by the stock search unit, as a goods receiving store from which the customer receives the article, together with the order receiving store, and a commission calculation unit that calculates commission for the goods receiving store, based on information for sales notified from the goods receiving store when the customer receives the article at the goods receiving store.

The sales mediation apparatus according to another aspect of this invention, comprises a stock search unit that receives a request from an order receiving store, of a plurality of stores, having received an order of an article or articles from a customer, and searches for stock of the article or articles across the other stores. The apparatus also comprises a management unit that manages one of the other stores having the stock hit as a result of search by the stock search unit, as a goods receiving store from which the customer receives the article, together with the order receiving store, and a commission calculation unit that calculates commission for the goods receiving store, based on information for sales notified from the goods receiving store when the customer receives the article at the goods receiving store.

The sales mediation method according to still another aspect of this invention, comprises steps of receiving a request from an order receiving store, of a plurality of stores, having received an order of an article or articles from a customer, and searching for stock of the article or articles across the other stores. The method also comprises steps of managing one of the other stores having the stock hit as a result of search in the step of searching for the stock, as a goods receiving store from which the customer receives the article, together with the order receiving store, and calculating commission for the goods receiving store, based on information for sales notified from the goods receiving store when the customer receives the article at the goods receiving store.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram showing the configuration of one embodiment according to the present invention,

FIG. 2 is a diagram showing a goods order receipt 150A shown in FIG. 1,

FIG. 3 is a diagram showing a receipt 150B indicating details of articles shown in FIG. 1;

FIG. 4 is a diagram showing a table structure of stock information database 310 shown in FIG. 1,

FIG. 5 is a diagram showing a table structure of order reception information database 320 shown in FIG. 1,

FIG. 6 is a diagram showing a table structure of sales information database 330 shown in FIG. 1,

FIG. 7 is a diagram showing a table structure of commission information database 340 shown in FIG. 1,

FIG. 8 is a flowchart for explaining the operation of a POS terminal 100A on the store A side shown in FIG. 1,

FIG. 9 is a flowchart for explaining the operation of a sales mediation apparatus 300 shown in FIG. 1,

FIG. 10 is a flowchart for explaining the operation of a POS terminal 100B on the store B side shown in FIG. 1,

FIG. 11 is a sequence diagram for explaining a cash flow in the embodiment,

FIG. 12 is a diagram showing an article information screen 400 displayed on a display 101A shown in FIG. 1,

FIG. 13 is a diagram showing the article information screen 400 displayed on the display 101A shown in FIG. 1,

FIG. 14 is a diagram showing the article information screen 400 and a stock screen 410 of the other store displayed on the display 101A shown in FIG. 1,

FIG. 15 is a diagram showing a stock detail screen 420 of the other store displayed on the display 101A shown in FIG. 1,

FIG. 16 is a diagram showing a sales screen 430 displayed on the display 101B shown in FIG. 1,

FIG. 17 is a diagram showing a settlement screen 440 displayed on the display 101B shown in FIG. 1,

FIG. 18 is a diagram for explaining a virtual stock shift in the sales mediation apparatus 300 shown in FIG. 1,

FIG. 19 is a diagram showing update of the stock information database 310 shown in FIG. 1, and

FIG. 20 is a block diagram showing the configuration of a modified example of the embodiment.

### DETAILED DESCRIPTIONS

One embodiment of the sales mediation program, the sales mediation apparatus, and the sales mediation method is explained in detail below with reference to the drawings.

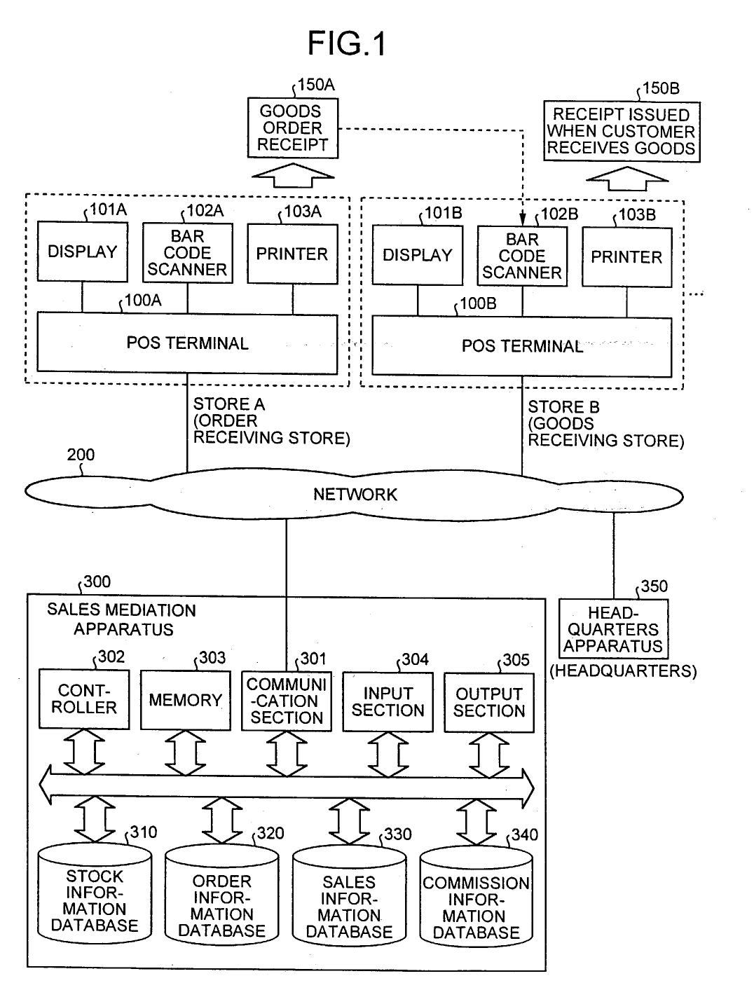

FIG. 1 is a block diagram showing the configuration of one embodiment of the present invention. In this figure, store A, store B, . . . are developed in various areas by the headquarters as chain stores, and for example, these stores sell articles such as shirts and neckties.

The store A and store B are away from each other, and located in different areas. The store A is located in the place of work of a certain customer (hereinafter simply referred to as a customer), and the store B is located in the place of residence of the customer.

In the embodiment, an example is explained, such that the customer only orders an article in the store A (in his/her place of work) on the way home from the office, and receives the article in the store B (in his/her place of residence) and pays for it some time on a holiday. Therefore, the store A is an order receiving store that receives an order of an article from the customer. On the other hand, the store B is a goods receiving store where the customer receives the article.

In the store A (order receiving store), a point of sales (POS) terminal 100A on the store A side is a device in the POS system capable of notifying a computer of data such as article codes at a point in time when the articles are sold, that is, at a point in time when the sales are recorded in a cash register through an article bar code or magnetic record attached to each article, totaling the quantity of sales of respective articles or well-selling articles in real time, and analyzing the sold articles.

The POS terminal 100A of the store A has a function of receiving an order of an article from a customer and a function of making a request of the sales mediation apparatus 300 described below to search other stores (for example, store B) for stock of the article, in addition to a basic function of the POS system.

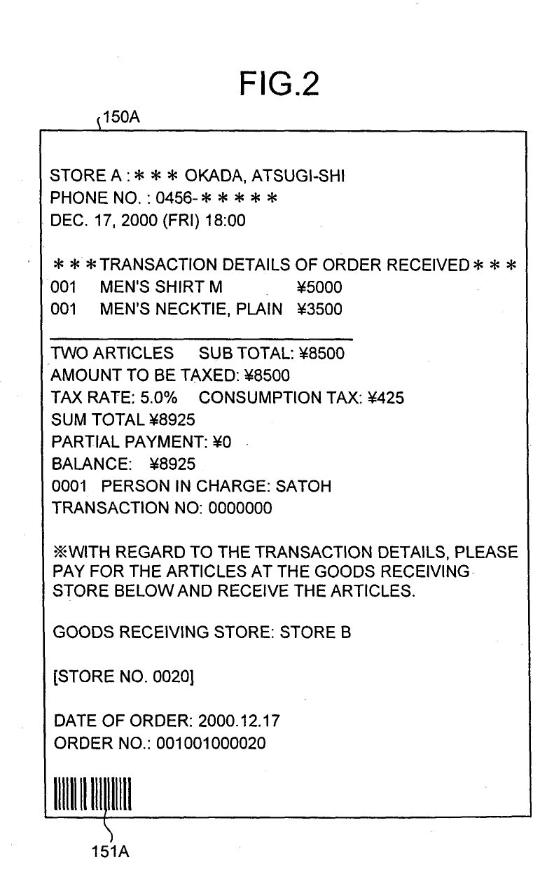

Further, the POS terminal 100A of the store A has a function of making a request of the sales mediation apparatus 300 to sell the article in the other store (for example, store B) having the stock of the article, and a function of issuing a goods order receipt 150A (see FIG. 2).

On the goods order receipt 150A shown in FIG. 2, contents of the articles ordered from the customer in the store A are printed. Specifically, the address and phone number of the store A, date on which the articles are ordered, article information in the order receiving store (article name, amount, and breakdown of the amount), name of the person in charge, the goods receiving store (store B in this figure), and bar code 151A are printed on the goods order receipt 150A. In this bar code 151A, the article information in the order receiving store is coded and displayed.

This goods order receipt 150A is handed from the store A to the customer after receiving the order of the articles, and is used as an exchange reference at the store B (goods receiving store).

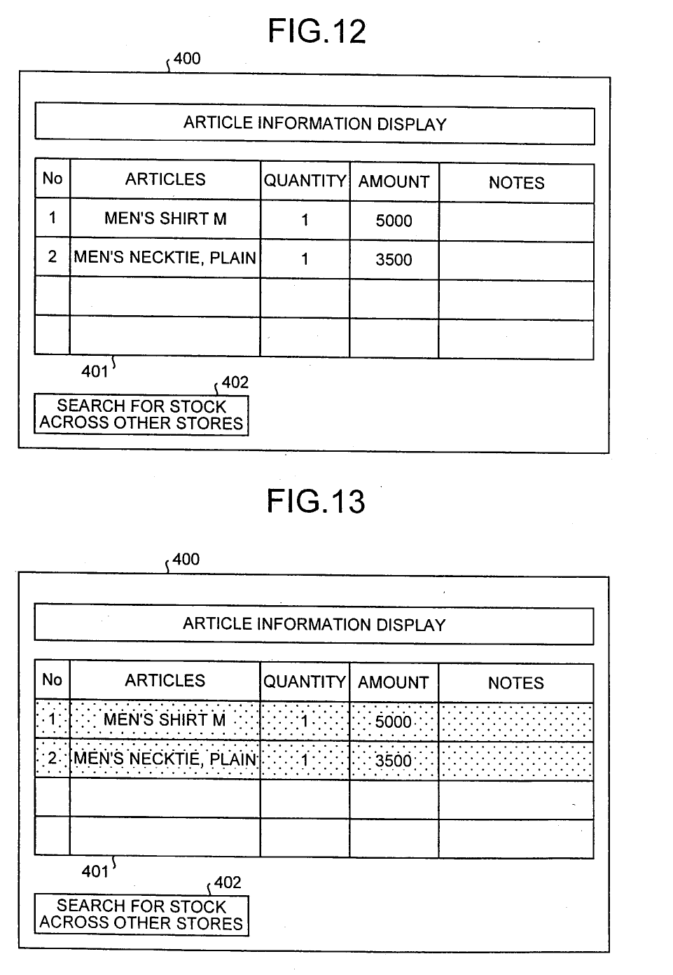

Returning to FIG. 1, the POS terminal 100A of the store A is connected with a display 101A, a bar code scanner 102A, and a printer 103A. The display 101A displays various screens (see FIG. 12 to FIG. 15) described later. The bar code scanner 102A is a handy scanner that optically reads the bar code. The printer 103A prints the goods order receipt 150A (see FIG. 2), general receipts, and the like.

On the other hand, in the store B (goods receiving store), the POS terminal 100B of the store B has a function of reading the bar code 151A from the goods order receipt 150A (see FIG. 2) brought in by the customer, and a function of accepting purchase of additional articles at the store B, in addition to the articles ordered at the store A, as well as the basic function of the POS system in the same manner as the POS terminal 100A of the store A.

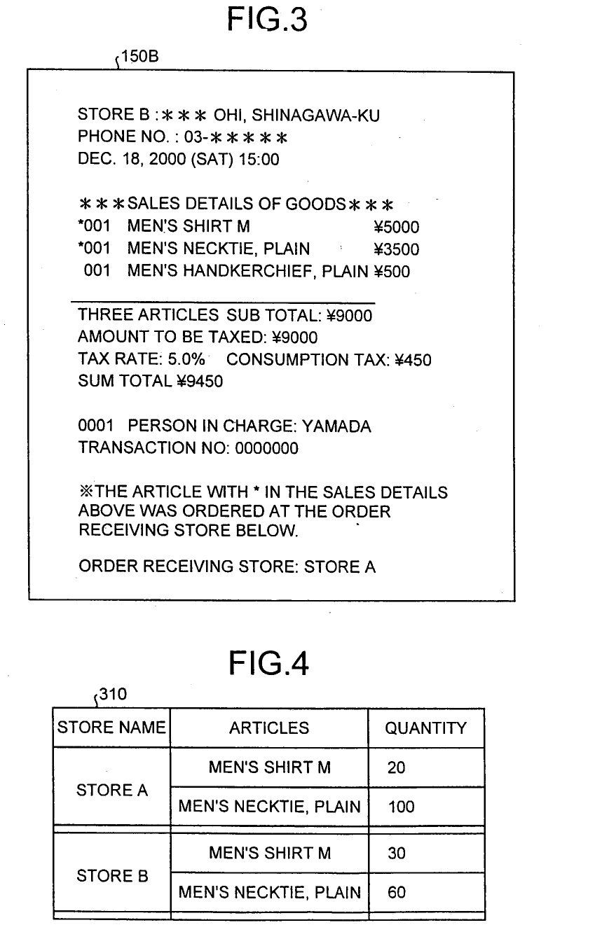

Further, the POS terminal 100B of the store B has a function of settling the account of the articles, a function of issuing a receipt 150B indicating details of the articles that the customer receives (see FIG. 3), and a function of transmitting the sales information to the sales mediation apparatus 300.

On the receipt 150B shown in FIG. 3, detailed statement of sales of the articles that the customer receives at the store B (articles ordered at the store A and additional articles purchased at the store B) is printed.

Specifically, the address and phone number of the store B, articles received date, articles sales information (article name, amount, and breakdown of the amount), name of the person in charge, the order receiving store (store A in this figure) are printed on the receipt 150B. This receipt 150B is handed from the store B to the customer after payment is made and the articles are received.

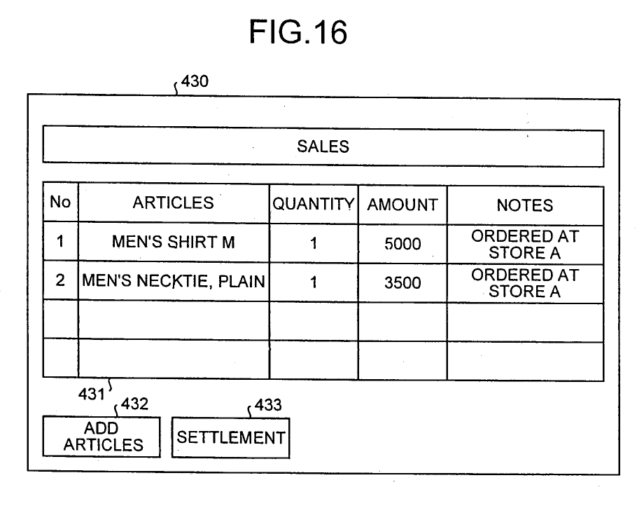

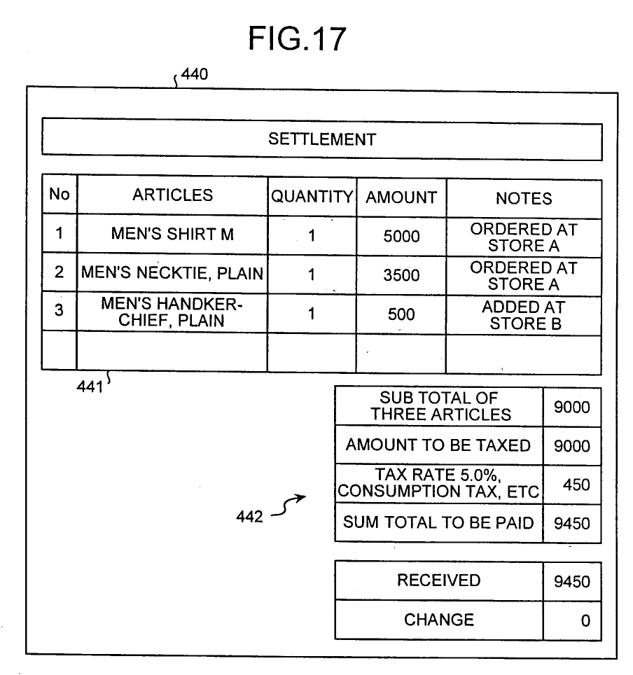

Returning to FIG. 1, the POS terminal 100B of the store B is connected with a display 101 B, a bar code scanner 102B, and a printer 103B. The display 101B displays various screens (see FIG. 16 to FIG. 17) described later. The bar code scanner 102B is a handy scanner that optically reads the bar code. The printer 103B prints the receipt 150B (see FIG. 3) and general receipts.

The sales mediation apparatus 300 is connected to the POS terminal 100A of the store A, the POS terminal 100B of the store B, . . . and the headquarters apparatus 350 via the network 200, and is an apparatus having various functions for mediating sales of articles between the order receiving stores and the goods receiving stores in a plurality of stores (store A, store B, . . . ).

Specifically, the sales mediation apparatus 300 has a function of managing article stock in each store (store A, store B, . . . ), a function of managing order of articles, a function of managing sales, and a function of managing the commission.

In the sales mediation apparatus 300, a communication section 301 controls communication in accordance with a predetermined communication protocol. A controller 302 realizes various functions of the sales mediation apparatus 300, while referring to respective databases (stock information database 310 to commission information database 340). The details of the operation of the controller 302 are described later.

A memory 303 stores various information handled by the controller 302. An input section 304 is an input device such as a keyboard and a mouse. An output section 305 is a display, a printer, and the like.

The stock information database 310 stores stock information relating to the stock status of articles in each store. Specifically, as shown in FIG. 4, the stock information database 310 comprises fields of “store name”, “articles”, and “quantity”.

“Store name” is information relating to the name of each store (store A, store B, . . . ). “Articles” is information relating to articles as the stock in the store. “Quantity” is information relating to the quantity of stock of the articles.

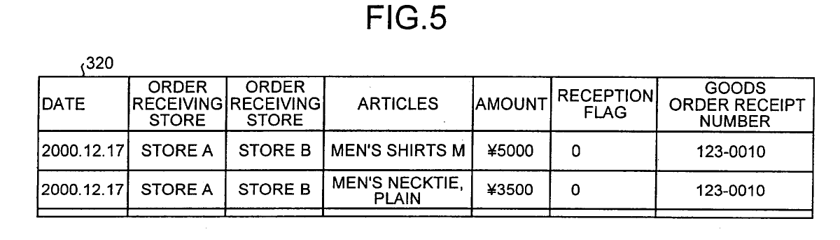

Returning to FIG. 1, the order reception information database 320 stores order reception information relating to orders of articles in order receiving stores (for example, store A). Specifically, the order reception information database 320 comprises, as shown in FIG. 5, fields of “date”, “order receiving store”, “goods receiving store”, “articles”, “amount”, “reception flag”, and “goods order receipt number”.

“Date” is information relating to the date when the articles are ordered at the order receiving store. “Order receiving store” is a name of a store where the articles are ordered (for example, store A). “Goods receiving store” is a name of a store where the customer actually receives the ordered articles (for example, store B). “Articles” is information relating to the ordered articles. “Amount” is information relating to the sales price of the articles.

“Reception flag” indicates the reception situation of the articles that are ordered in the order receiving store. Specifically, when the customer has not received the articles at the goods receiving store, the “reception flag” is set to 0. On the other hand, when the customer has received the articles at the goods receiving store, the “reception flag” is set to 1. “Goods order receipt number” is a number for identifying the goods order receipt 150A (see FIG. 2).

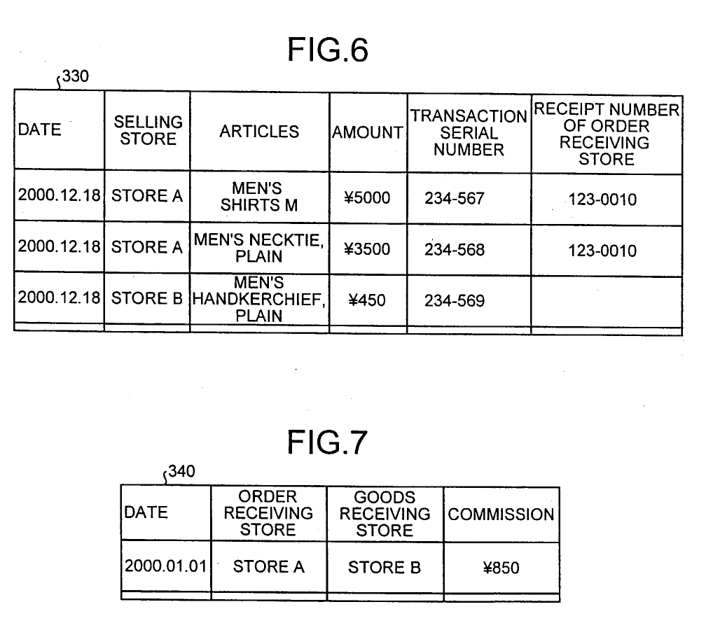

Returning to FIG. 1, the sales information database 330 stores sales information relating to the sales of the articles in each store. Specifically, the sales information database 330 consists of, as shown in FIG. 6, fields of “date”, “selling store”, “articles”, “amount”, “transaction serial number”, and “goods order receipt number”.

“Date” is information relating to the date on which the customer receives the articles at the goods receiving store and makes payment, and on which the sales are recorded. “Selling store” is information relating to the store in which the sales of the articles are recorded.

When the articles are ordered at the order receiving store and the articles are received at the goods receiving store afterward, the order receiving store is recorded as the selling store of the articles. Further, if the goods receiving store separately sells articles not through an order receiving store, the goods receiving store is recorded as the selling store of the articles.

“Articles” is information relating to the articles to be sold. “Amount” is information relating to the sales price of the articles. “Transaction serial number” is information relating to the serial number of transaction. “Goods order receipt number” is a number for identifying the goods order receipt 150A (see FIG. 2).

Returning to FIG. 1, the commission information database 340 stores commission information relating to the commission paid from the order receiving store to the goods receiving store, as the consideration for the sales (customer receives the articles and pays for them) at the goods receiving store, relating to the articles ordered at the order receiving store.

Specifically, the commission information database 340 consists of fields such as “date”, “order receiving store”, “goods receiving store”, and “commission”, as shown in FIG. 7. “Date” is information relating to the date on which the commission information is stored in the commission information database 340.

“Order receiving store” is information relating to the store that receives an order of articles and pays the commission. “Goods receiving store” is information relating to the store from which the customer receives the articles and to which the commission is paid. “Commission” is information relating to the amount paid from the order receiving store to the goods receiving store, and for example, the commission corresponds to 10% of the amount of the articles.

Returning to FIG. 1, the headquarters apparatus 350 is installed in the headquarters that develops chain stores (store A, store B, . . . ,), and is a computer for performing sales control over the whole stores.

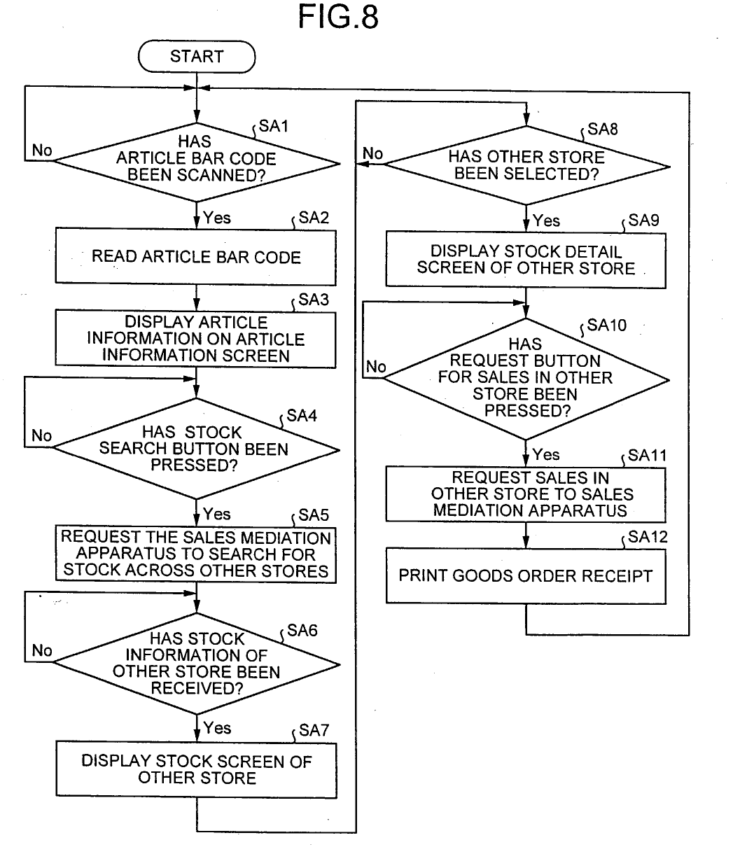

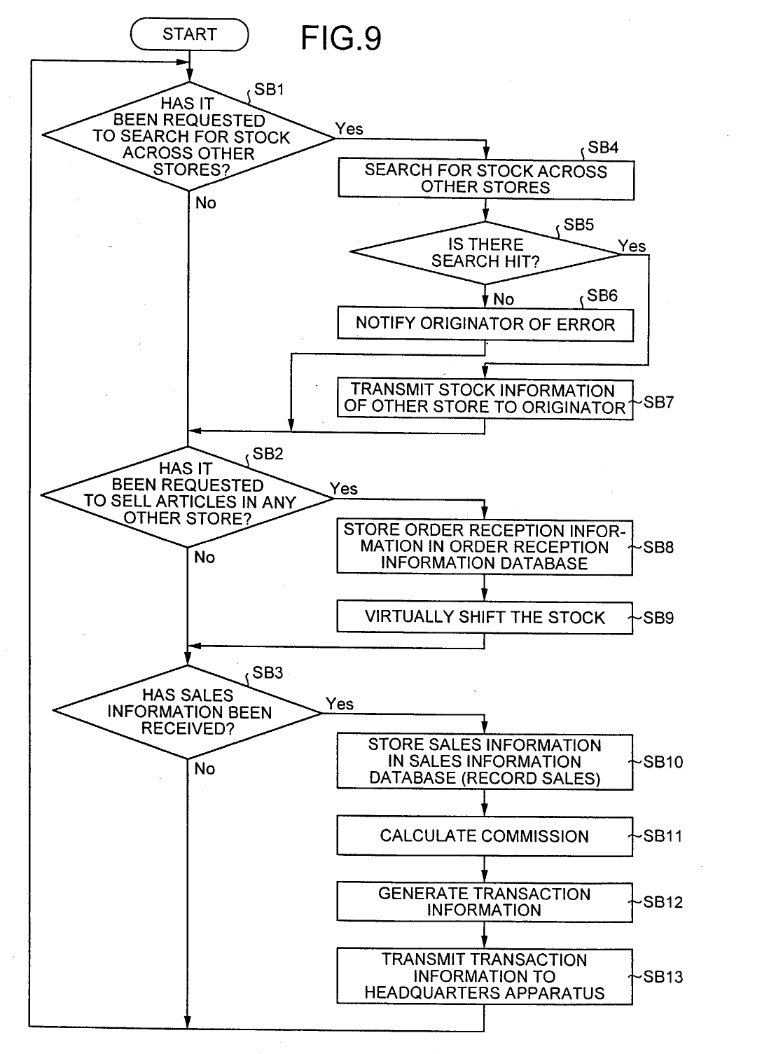

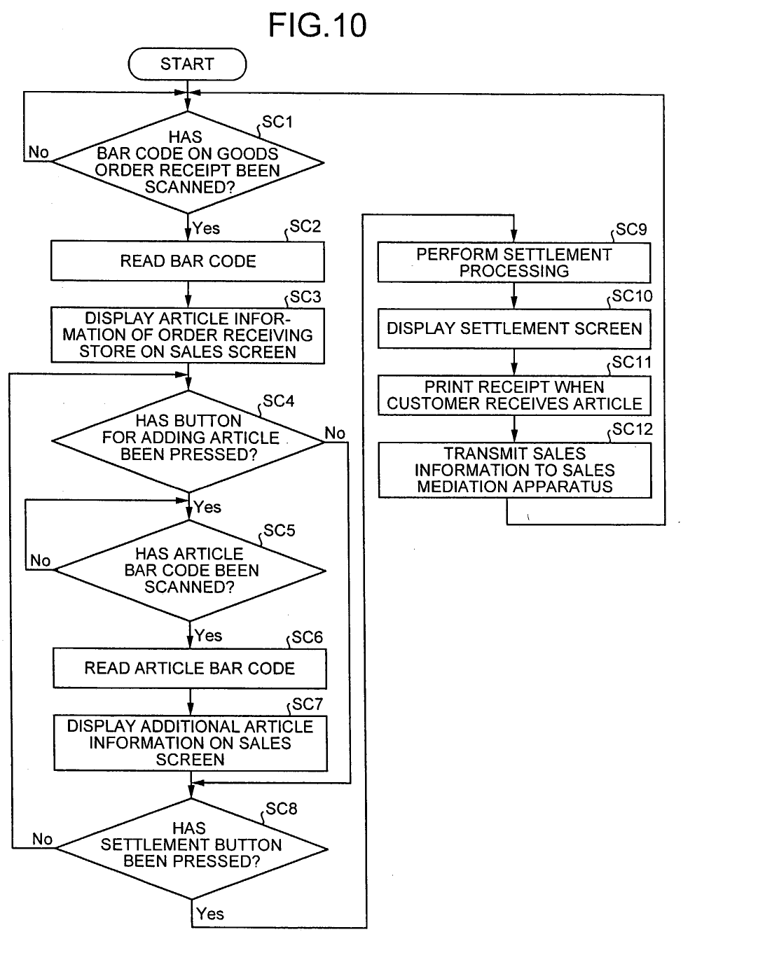

The operation in the embodiment is explained with reference to the flowcharts shown in FIG. 8 to FIG. 10. FIG. 8 is a flowchart for explaining the operation of the POS terminal 100A of the store A shown in FIG. 1. FIG. 9 is a flowchart for explaining the operation of the sales mediation apparatus 300 shown in FIG. 1. FIG. 10 is a flowchart for explaining the operation of the POS terminal 100B on the store B side shown in FIG. 1.

An example is explained below, in which a customer only orders articles (“men's shirts M”, and “men's necktie, plain”: see FIG. 6) in the store A (in the place of work) on the way home from the office, and visits the store B (his/her place of residence) on a holiday to receive the articles as well as additional articles (“men's handkerchief, plain”: see FIG. 6) and pays for these.

At step SA1 shown in FIG. 8, the POS terminal 100A of the store A judges whether an article bar code added to each article to be ordered has been scanned by the bar code scanner 102A, and in this case, it judges “No”, and repeats this judgment.

At step SB1 shown in FIG. 9, the controller 302 in the sales mediation apparatus 300 judges whether it has been requested to search for stock across other stores by a POS terminal installed in the order receiving store, for example, the POS terminal 100A of the store A, and in this case, the judgment result is “No”.

At step SB2, the controller 302 judges whether it has been requested to sell articles in any other store by a POS terminal installed in the order receiving store, for example, the POS terminal 100A of the store A, and in this case, the judgment result is “No”.

At step SB3, the controller 302 judges whether sales information has been received from a POS terminal installed in the goods receiving store, for example, the POS terminal 100B of the store B, and in this case, the judgment result is “No”. Steps SB1 through SB3 are repeated until the judgment results become “Yes”.

At step SC1 shown in FIG. 10, the POS terminal 100B of the store B judges whether the bar code 151A on the goods order receipt 150A (see FIG. 2) has been scanned by the bar code scanner 102B, and in this case, the judgment result is “No”, and therefore the judgment is repeated.

When the customer visits the store A in the place of work, and hands two articles, “men's shirts M” and “men's necktie, plain”, to a shop assistant A, and tells that he wants to receive the articles at the store B in his place of residence. The shop assistant A then scans the article bar code attached to the respective articles of “men's shirts M” and “men's necktie, plain”, by the bar code scanner 102A.

Thereby, the POS terminal 100A of the store A judges “Yes” at step SA1 shown in FIG. 8. At step SA2, the POS terminal 100A of the store A reads the article bar code by the bar code scanner 102A. At step SA3, the POS terminal 100A of the store A displays the article information relating to the “men's shirts M” and “men's necktie, plain” on an article information screen 400 shown in FIG. 12, displayed on the display 101A.

In FIG. 12, article information, that is, the number and the amount of “men's shirts M” and “men's necktie, plain”, is displayed in the article information display column 401. The quantity of “men's shirts M” is 1, and the amount thereof is 5,000 yen. The quantity of “men's necktie, plain” is 1 and the amount thereof is 3,500 yen.

At step SA4, the POS terminal 100A of the store A judges whether a stock search button 402 on the article information screen 400 is pressed. In this case, the judgment result is “No”, and therefore the judgment is repeated. This stock search button 402 is used to search for stock across other stores (in this case, store B as a goods receiving store), using the articles ordered at the store A (in this case, “men's shirts M” and “men's necktie, plain”) as a search key.

The shop assistant A selects two articles (half-tone dotted portion) shown in FIG. 13, and presses the stock search button 402. The POS terminal 100A of the store A then judges the result made at step SA4 as “Yes”. At step SA5, the POS terminal 100A of the store A requests the sales mediation apparatus 300 to search for stock across other stores, via the network 200.

At this time, the POS terminal 100A of the store A transmits the article information (in this case, “men's shirts M” and “men's necktie, plain”) as the search key to the sales mediation apparatus 300. At step SA6, the POS terminal 100A of the store A judges whether the stock information of the other store has been received from the sales mediation apparatus 300, in response to the request at step SA5, and in this case, it judges “No”, and repeats the judgment.

When a request for searching for stock across other stores has been received from the POS terminal 100A of the store A, the controller 302 in the sales mediation apparatus 300 judges the result made at step SB1 shown in FIG. 9 as “Yes”. At this time, the sales mediation apparatus 300 receives the information of articles (“men's shirts M” and “men's necktie, plain”) as the search key from the POS terminal 100A of the store A.

At step SB4, the controller 302 searches the stock information database 310 shown in FIG. 4, using the articles (“men's shirts M” and “men's necktie, plain”) as the search key. In this case, since the store B shown in FIG. 4 has the articles (“men's shirts M” and “men's necktie, plain”), there is a search hit. At step SB5, the controller 302 judges whether there is a search hit, and in this case, the judgment result is “Yes”.

When the judgment result is “No”, at step SB6, the controller 302 notifies the POS terminal 100A of the store A being an originator of the request, of the error.

At step SB7, the controller 302 transmits the stock information of the other store (for example, store name: store B, available number: 2) to the POS terminal 100A of the store A, being the originator of the request. The available number is a number that can be reserved at the store B when the articles ordered at the store A are to be reserved at the store B, and the number is set in advance.

When receiving the stock information of the other store, the POS terminal 100A of the store A judges the search result as “Yes” at step SA6 shown in FIG. 8.

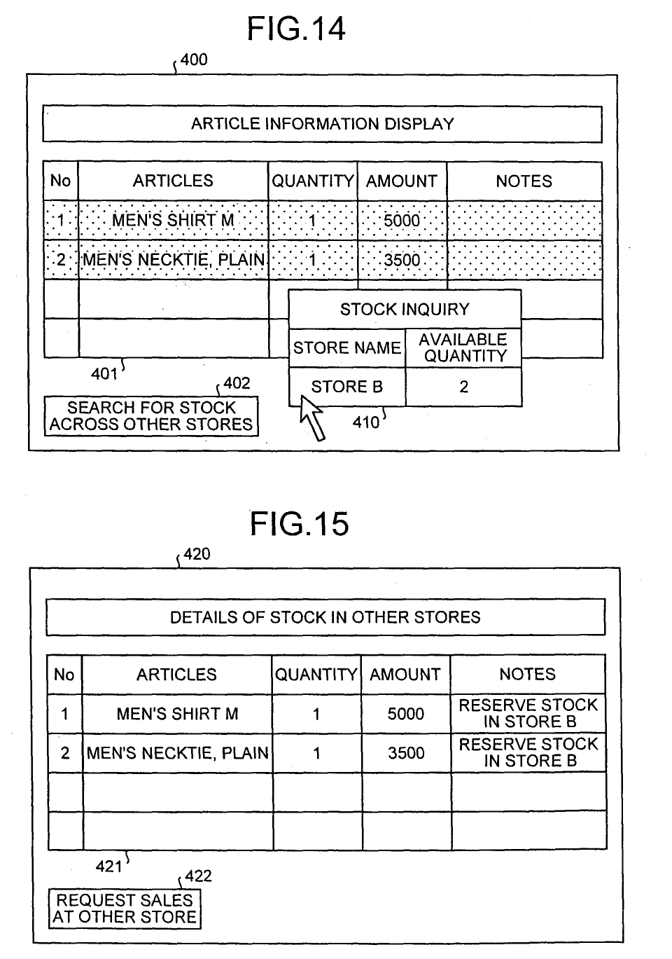

At step SA7, the POS terminal 100A of the store A displays a stock screen 410 of the other store on the article information screen 400 shown in FIG. 14, based on the received stock information of the other store. By this stock screen 410 of the other store, the shop assistant A recognizes that there is a stock of the articles in the store B, and informs the customer that it is possible to receive the articles at the store B.

At step SA8, the POS terminal 100A of the store A judges whether the other store (in this case, store B) has been selected on the stock screen 410 of the other store by the shop assistant A, and in this case, it judges the result as “No”, and repeats the judgment. When the shop assistant A selects store B as the other store on the stock screen 410 of the other store, the POS terminal 100A of the store A judges the result at step SA8 as “Yes”.

At step SA9, the POS terminal 100A of the store A displays a stock detail screen 420 of the other store shown in FIG. 15 on the display 101A. On this stock detail screen 420 of the other store, details (article, quantity, amount, notes) of the stock information in the other store (store B) are displayed in the stock details information display column 421.

At step SA10, the POS terminal 100A of the store A judges whether a request button 422 for sales at the other store on the stock detail screen 420 of the other store has been pressed, and in this case, it judges the result as “No”, and repeats the judgment. The button 422 is used for requesting the sales mediation apparatus 300 to sell the articles (in this case, “men's shirts M” and “men's necktie, plain”) ordered at the store A, at the store B being an other store. In the sales at the store B, the stock articles in the store B are sold.

When the shop assistant A presses the button 422, the POS terminal 100A of the store A judges the result as “Yes” at step SA10. At step SA11, the POS terminal 100A of the store A requests the sales mediation apparatus 300 to sell the articles at the other store (sales at the store B) via the network 200. At this time, the POS terminal 100A of the store A transmits the order reception information relating to the articles (“men's shirts M” and “men's necktie, plain”) ordered at the store A, to the sales mediation apparatus 300.

At step SA12, the POS terminal 100A of the store A prints the goods order receipt 150A shown in FIG. 2 by the printer 103A. On this goods order receipt 150A, the article information ordered at the store A, the amount, the goods receiving store (store B), and the bar code 151A are printed. The shop assistant A hands the goods order receipt 150A to the customer, and tells him to receive the articles at the store B. At the store A, the customer does not pay for the articles.

When the other store sales is requested from the POS terminal 100A of the store A to the sales mediation apparatus 300 and the sales mediation apparatus 300 receives the order reception information, the controller 302 judges the result at step SB2 shown in FIG. 9 as “Yes”. At step SB8, the controller 302 stores the order reception information relating to the articles (“men's shirts M” and “men's necktie, plain”) ordered at the store A, in the order reception information database 320 shown in FIG. 5.

At this time, the “reception flag” in the order reception information database 320 is set to 0. The controller 302 notifies the POS terminal 100B of the store B of a request to keep the articles ordered at the store A.

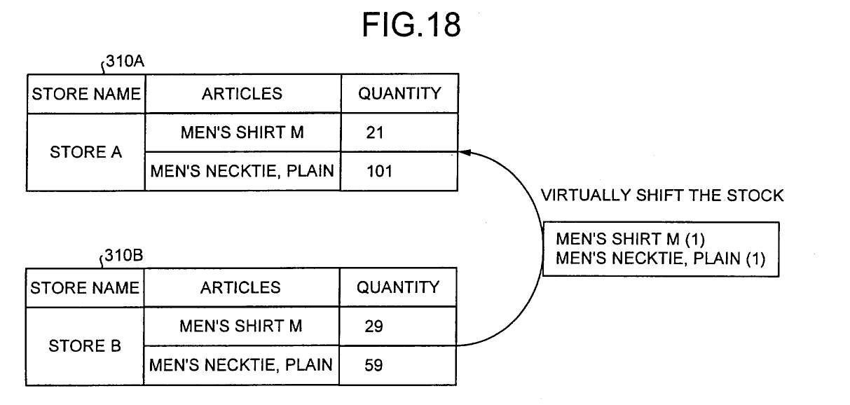

At step SB9, as shown in FIG. 18, the controller 302 virtually shifts the ordered articles from the store B (goods receiving store) to the store A (order receiving store) in the memory 303. Specifically, the controller 302 shifts the stock information in the store B (men's shirts M (1) and men's necktie, plain (1)) from the stock information table 310B of the store B to the stock information table 310A of the store A on the memory 303.

The customer handed over the goods order receipt 150A at the store A visits the store B close to his place of residence, for example, on a holiday. Here, the customer selects “men's handkerchief, plain” as an additional purchase article, and hands this “men's handkerchief, plain” and the goods order receipt 150A shown in FIG. 2 to a shop assistant B. The shop assistant B scans the bar code 151A on the goods order receipt 150A by the bar code scanner 102B.

The POS terminal 100B of the store B judges the result at step SC1 shown in FIG. 10 as “Yes”. At step SC2, the POS terminal 100B reads the bar code 151A (see FIG. 2) through the bar code scanner 102B.

At step SC3, the POS terminal 100B displays the article information of the order receiving store relating to “men's shirts M” and “men's necktie, plain”, corresponding to the bar code 151A, on the sales screen 430 shown in FIG. 16 displayed on the display 101B.

In FIG. 16, the article information of the order receiving store, that is, the quantity and the amount of “men's shirts M” and “men's necktie, plain” ordered at the store A, and notes (ordered at the store A) is displayed in a column 431 where the article information for the order receiving store is displayed. The quantity of “men's shirts M” is 1 and the amount thereof is 5,000 yen, and the quantity of “men's necktie, plain” is 1, and the amount thereof is 3,500 yen.

At step SC4, the POS terminal 100B of the store B judges if an add article button 432 on the sales screen 430 has been pressed, and in this case, it judges the result as “Yes”.

The add article button 432 is a button pressed at the time of adding an article to be purchased at the store B (goods receiving store). When the judgment result at step SC4 is “No”, the POS terminal 100B of the store B performs judgment at step SB8 described later.

At step SC5, the POS terminal 100B judges whether the article bar code attached to each article to be additionally purchased (in this case, “men's handkerchief, plain”) has been scanned by the bar code scanner 102B, and in this case, it judges the result as “No”, and repeats the judgment.

When the shop assistant B scans the article bar code attached to each articles to be additionally purchased using the bar code scanner 102B, the POS terminal 100B of the store B judges the result at step SC5 as “Yes”.

At step SC6, the POS terminal 100B of the store B reads the article bar code through the bar code scanner 102B. At step SC7, the POS terminal 100B of the store B displays the additional article information (see FIG. 17, article: men's handkerchief, plain, quantity: 1, amount: 500, notes: added at the store B), on the sales screen 430 shown in FIG. 16 on the display 101B.

At step SC8, the POS terminal 100B of the store B judges whether a settlement button 433 on the sales screen 430 shown in FIG. 16 has been pressed, and in this case, the judgment result is “No”. This settlement button 433 is a button for settling the account for the articles.

When the shop assistant B presses the settlement button 433, the POS terminal 100B of the store B judges the result at step SC8 as “Yes”. At step SC9, the POS terminal 100B of the store B executes the settlement processing, that is, calculates consumption tax and sum total of payment, based on the amounts of articles (two articles ordered at the store A and one article added at the store B) purchased by the customer.

At step SC10, the POS terminal 100B of the store B displays the settlement screen 440 shown in FIG. 17 on the display 101B, based on the settlement processing.

In FIG. 17, article information including the quantity and amount of “men's shirt M” and “men's necktie, plain” (articles ordered at the store A), and “men's handkerchief, plain” (articles added at the store B) is displayed in the article information display column 441.

The quantity of “men's shirt M” is 1 and the amount is 5,000 yen. The quantity of “men's necktie, plain” is 1 and the amount is 3,500 yen. The quantity of “men's handkerchief, plain” is 1 and the amount is 500 yen. The settlement information including sub total (9,000 yen) of the three articles, consumption tax (450 yen), and total amount of payment (9,450 yen) is displayed in the settlement information display column 442.

The customer pays 9,450 yen (including tax) for the three articles to the shop assistant B, and receives the articles from the shop assistant B.

At step SC11, the POS terminal 100B of the store B prints the receipt 150B shown in FIG. 3 by the printer 103B. The sales details of the articles (articles ordered at the store A and additional articles added at the store B) are printed on this receipt 150B. The shop assistant B hands the receipt 150B to the customer.

At step SC12, the POS terminal 100B of the store B transmits the sales information relating to the three articles (date, selling store, articles, and amount, see FIG. 6) to the sales mediation apparatus 300, via the network 200.

When the sales mediation apparatus 300 receives the sales information, the controller 302 judges the result at step SB3 shown in FIG. 9 as “Yes”. At step SB10, the controller 302 stores the received sales information in the sales information database 330 shown in FIG. 6, and records the sales. The sales in this case are 8,500 yen (5,000+3,500) for the store A, and 500 yen for the store B.

At step SB11, the controller 302 calculates the commission to be paid from the store A to the store B, as the consideration for the sales (reception and payment) at the store B (goods receiving store), relating to the articles ordered at the store A (order receiving store).

In this case, the sales at the store A are 8,500 yen, and assuming that the commission rate is 10%, the commission becomes 850 yen (8,500×10%). The controller 302 then stores the commission information corresponding to the calculated commission in the commission information database 340 shown in FIG. 7.

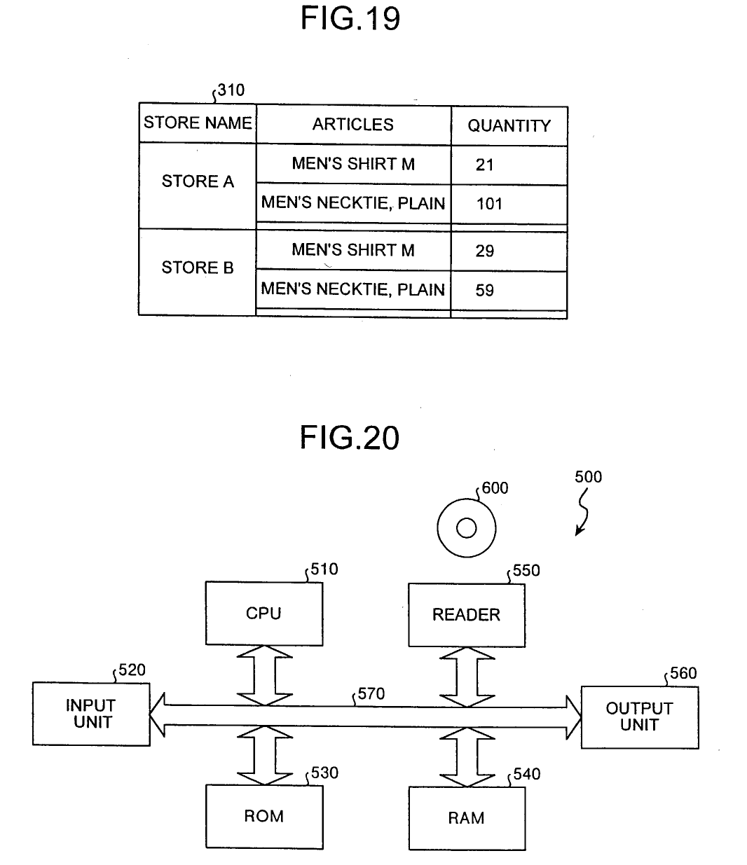

The controller 302 updates the stock information in the stock information database 310, as shown in FIG. 19, based on the virtual stock shift (see FIG. 18) at step SB9.

Specifically, the controller 302 shifts the stock (quantity 1, respectively) at the store B to the stock at the store A, for the consistency when “men's shirt M” and “men's necktie, plain” sold at the store B are recorded as the sales at the store A. The controller 302 also sets the reception flag shown in FIG. 5 to 1.

A step SB12, the sales mediation apparatus 300 generates transaction information (commission, sales for each store, and the like) relating to a series of transactions. At step SB13, the sales mediation apparatus 300 transmits the transaction information to the headquarters apparatus 350 via the network 200. Thereby, the commissions and the sales are distributed from the headquarters to the store A and the store B.

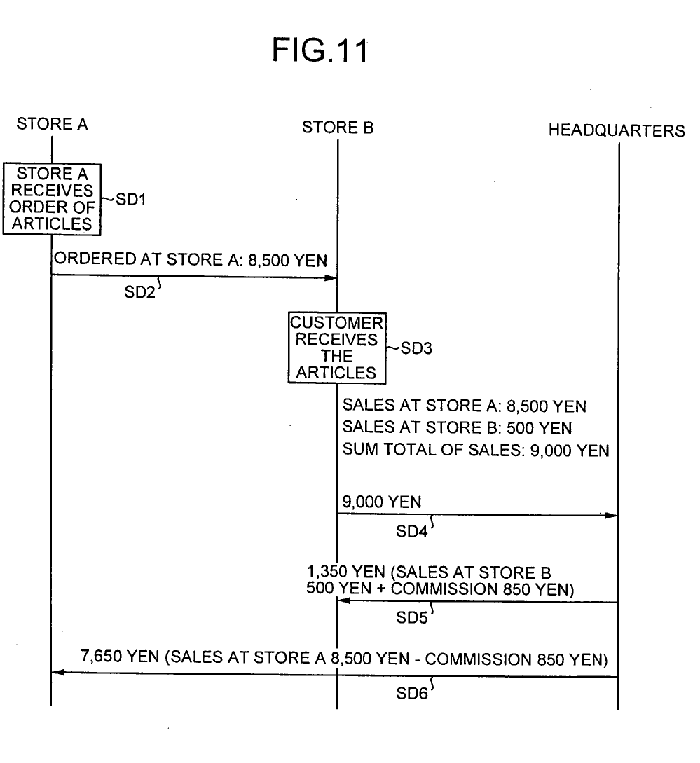

The cash flow in the embodiment is explained with reference to FIG. 11. In this figure, at step SD1, the store A receives an order of articles for 8,500. At step SD2, sales of the articles are requested from the store A to the store B.

At step SD3, when the customer receives the articles (8,500 yen) and the additional articles (500 yen), he/she pays 9,000 yen for the articles to the store B. At step SD4, the headquarters receive 9,000 yen numerically as a total of the sales.

At step SD5, the headquarters distributes 1,350 yen (sales at the store B 500 yen+commission 850 yen) to the store B, based on the transaction information. At step SD6, the headquarters distributes 7,650 yen (sales 8,500 yen at the store A—commission 850 yen) to the store A, based on the transaction information.

As explained above, according to the embodiment, the sales mediation apparatus 300 searches for stock of articles across other stores, based on a request from the POS terminal 100A installed in the store A (order receiving store) having received an order of the articles from a customer, and manages the other store having the stock as the store B (goods receiving store) where the customer receives the articles, together with the store A (order receiving store). When the customer has received the articles at the store B (goods receiving store), the sales mediation apparatus 300 calculates the commission for the store B (goods receiving store), based on the sales information informed from the POS terminal 100B of the store B. As a result, various needs of customers can be met, for example, the customer orders articles at an order receiving store, located in the place of work of the customer, and receives and pays for the articles at the store B (goods receiving store) in the place of his/her residence, as well as increasing the convenience. Further, the store side can make effectively use of a business chance.

According to the embodiment, since the commission to be paid from the store A (order receiving store) to the store B (goods receiving store) as the sales consideration is calculated, a financial advantage can be given to the store B (goods receiving store).

According to the embodiment, when the customer receives the articles at the store B (goods receiving store), the stock information is adjusted such that the stock at the store B (goods receiving store) corresponding to the articles is shifted to the stock at the store A (order receiving store). As a result, appropriate stock management can be performed.

According to the embodiment, since a request to keep the ordered articles is notified to the store B (goods receiving store), stock-out can be prevented.

The embodiment of the present invention has been explained in detail with reference to the drawings. However, the specific configuration example is not limited to the embodiment, and design changes without departing from the scope of the present invention are included in the present invention.

For example, in the embodiment, the program for realizing the functions of the sales mediation apparatus 300, the POS terminal 100A of the store A, or the POS terminal 100B of the store B may be recorded on a computer readable recording medium 600 shown in FIG. 20, and the program recorded on the recording medium 600 may be read by a computer 500 shown in the figure, and executed, to thereby realize the respective functions.

The computer 500 shown in this figure comprises a CPU (central processing unit) 510 that executes the program, an input unit 520 such as a keyboard, a mouse, and the like, a ROM (read only memory) 530 that stores various data, a RAM (random access memory) 540 that stores arithmetic parameters, a reader 550 that reads the program from the recording medium 600, an output unit 560 such as a display, a printer, and the like, and a bus 570 for connecting respective sections in the apparatus.

The CPU 510 reads the program recorded on the recording medium 600 through the reader 550, and executes the program, to thereby realize the functions. The recording medium 600 includes an optical disk, a flexible disk, and a hard disk.

In the embodiment, the functions of the sales mediation apparatus 300 may be provided in each of the POS terminal 100A of the store A and the POS terminal 100B of the store B to perform transactions directly between the POS terminal 100A and the POS terminal 100B, thus realizing the functions.

As explained above, according to the present invention, in response to a request from the order receiving store that receives an order of an article or articles from a customer, stock of the article or articles is searched across other stores, and one of the other stores having the stock is managed, together with the order receiving store, as the goods receiving store from which the customer receives the article. Thereafter, when the customer receives the article at the goods receiving store, the commission for the goods receiving store is calculated based on the sales information notified from the goods receiving store. As a result, it is advantageously possible to satisfy various needs of customers such that a customer wants to select an article at an order receiving store located in his/her place of work and receives the article and pays for it at a goods receiving store in his/her place of residence, thus increasing the convenience. Further, it is advantageously possible for the store to make effectively use of a business chance.

Furthermore, since the commission is calculated as the sales consideration to be paid from the order receiving store to the goods receiving store, the goods receiving store can be given a financial advantage.

Moreover, when the customer receives the article at the goods receiving store, the stock information is adjusted so that the stock in the goods receiving store corresponding to the article is shifted to the stock in the order receiving store. Hence, it is advantageously possible to carry out appropriate stock management.

Furthermore, since a request to keep the ordered article is notified to the goods receiving store, stock-out can be prevented.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A sales mediation program by which a computer functions as:
a stock search unit that receives a request from an order receiving store, of a plurality of stores, having received an order of an article or articles from a customer, and searches for stock of the article or articles across the other stores;
a management unit that manages one of the other stores having the stock hit as a result of search by the stock search unit, as a goods receiving store from which the customer receives the article, together with the order receiving store; and
a commission calculation unit that calculates commission for the goods receiving store, based on information for sales notified from the goods receiving store when the customer receives the article at the goods receiving store.

2. The sales mediation program according to claim 1, wherein the commission calculation unit calculates commission as consideration for the sales to be paid from the order receiving store to the goods receiving store.

3. The sales mediation program according to claim 1, by which the computer further functions as:
a stock information adjusting unit that adjusts the stock information so that the stock in the goods receiving store corresponding to the article is shifted to the stock in the order receiving store when the customer receives the article at the goods receiving store.

4. The sales mediation program according to claim 1, by which the computer further functions as a keeping notifying unit that notifies the goods receiving store of a request to keep the ordered article.

5. A sales mediation apparatus comprising:
a stock search unit that receives a request from an order receiving store, of a plurality of stores, having received an order of an article or articles from a customer, and searches for stock of the article or articles across the other stores;
a management unit that manages one of the other stores having the stock hit as a result of search by the stock search unit, as a goods receiving store from which the customer receives the article, together with the order receiving store; and
a commission calculation unit that calculates commission for the goods receiving store, based on information for sales notified from the goods receiving store when the customer receives the article at the goods receiving store.

6. The sales mediation apparatus according to claim 5, wherein the commission calculation unit calculates commission as consideration for the sales to be paid from the order receiving store to the goods receiving store.

7. The sales mediation apparatus according to 5, further comprising a stock information adjusting unit that adjusts stock information so that the stock in the goods receiving store corresponding to the article is shifted to the stock in the order receiving store when the customer receives the article at the goods receiving store.

8. The sales mediation apparatus according to claim 5, further comprising a keeping notifying unit that notifies the goods receiving store of a request to keep the ordered article.

9. A sales mediation method comprising steps of:
receiving a request from an order receiving store, of a plurality of stores, having received an order of an article or articles from a customer, and searching for stock of the article or articles across the other stores;
managing one of the other stores having the stock hit as a result of search in the step of searching for the stock, as a goods receiving store from which the customer receives the article, together with the order receiving store; and
calculating commission for the goods receiving store, based on information for sales notified from the goods receiving store when the customer receives the article at the goods receiving store.

10. The sales mediation method according to claim 9, wherein the step of calculating the commission includes calculating commission as consideration for the sales to be paid from the order receiving store to the goods receiving store.

11. The sales mediation method according to claim 9, further comprising a step of adjusting stock information so that the stock in the goods receiving store corresponding to the article is shifted to the stock in the order receiving store when the customer receives the article at the goods receiving store.

12. The sales mediation method according to claim 9, further comprising a step of notifying the goods receiving store of a request to keep the ordered article.
